(19) United States
(12) Patent Application Publication
(10) Pub. No.: US 2017/0190584 A1
(43) Pub. Date: Jul. 6, 2017

(54) METHOD FOR PREPARING NANOPARTICLES BY USING LASER

(71) Applicants: Won Il CHO, Busan (KR); SHONANO CO., LTD, Ulsan (KR)

(72) Inventors: Won Il CHO, Busan (KR); Seong Beom KIM, Ulsan (KR)

(21) Appl. No.: 15/313,684

(22) PCT Filed: Oct. 15, 2015
(86) PCT No.: PCT/KR2015/010902

§ 371 Date: Nov. 23, 2016

(30) Foreign Application Priority Data
Dec. 16, 2014 (KR) 10-2014-0181701

(51) Int. Cl. C01B 33/021; C01G 17/00; B01J 27/12; B01J 19/08; B82B 3/00

(52) U.S. Cl. CPC C01B 33/021; B01J 19/08; B82B 3/0004; B01J 27/12; C01G 17/00

(57) ABSTRACT

The present invention relates to a method for preparing nanoparticles by using laser and more particularly, a method for preparing nanoparticles by irradiating a laser beam to the mixture of a source material gas and a hexafluoride (SF₆) catalyst gas, thereby improving the production yield of nanoparticles with energy saved. More particularly, the present invention provides the method for preparing the nanoparticles by using the laser wherein the laser beam of wavelength having the excellent energy absorption by the mixture gas of source material gas and catalyst gas is irradiated to the mixture gas so as to increase the reactivity of the source material gas with energy saved, which brings the effects of solving the problems of damaging environment due to the unreacted toxic source material gas incurred by the low production yield of the conventional nanoparticle preparation method and of making system complicated with the high cost when the discarded source gas is recovered and reused.

### TECHNICAL FIELD

The present invention relates to a method for preparing nanoparticles by using laser and more particularly, a method for preparing nanoparticles by irradiating a laser beam to the mixture of a source material gas and a hexafluoride (SF₆) catalyst gas, thereby improving the production yield of nanoparticles with energy saved.

### BACKGROUND OF THE INVENTION

Nanotechnology, the core technology of the 21^{st} century science, is recognized as the next generation growth engine that not only drives the technology innovation associated with the conventional manufacturing industry, but plays a key technology to better advance the future core businesses by converging the advanced technologies such as IT, BT and CT. The manufacturing methods of nanomaterials applied for such advanced technologies include laser heating method, liquid synthesis method, and solid synthesis method. The liquid synthesis method is basically the batch process and has the difficulties in synthesizing the high purity nanoparticles since the method is necessarily accompanied with making contact with the foreign substances and other various solvents. However, the laser heating method has advantages of making no contact with the impurities and allowing the continuous preparation of nanoparticles.

Referring to the nanoparticle manufacturing equipment by laser heating method, the nanoparticle synthesis equipment using CO₂ laser pyrolysis method as shown in FIG. 1 and FIG. 2 (Ref. Kim Sungbeom etc. Korea Materials Society, 23 (2013) 5) comprises laser emitter (10), reaction chamber (20), collector (30), vacuum pump (40), source material supply nozzle (50a) for supplying the source material like monosilane (SiH₄) into said reaction chamber (20) and infusion section (50) having carrier gas supply nozzle (50b) for supplying the carrier gas. The process of preparing nanoparticles by said equipment is as follows. The laser beam emitted from the laser emitter (10) is irradiated into the reaction chamber (20) through the reflection mirror and the lens. The source material such as monosilane (SiH₄) infused into the reaction chamber through the source material supply nozzle (50a) of the infusion section (50) is decomposed by the heat of laser beam, and thus the nanoparticles (60) are produced. The uniformly grown nanoparticles within the reaction chamber (20) get out of the chamber as the negative pressure is developed in the reaction chamber by the vacuum pump (40), and are collected by the collector (30).

The prior arts regarding the nanoparticle preparation method by laser heating as described above include Korea publication of unexamined patent applications 10-2013-0130284, “Nanoparticle synthesis equipment and method thereof by using laser” in which the source materials such as silicon, germanium, silicon-germanium alloy, III-IV semiconductor compound, and metal oxide compound are irradiated by the laser, WO publication of unexamined patent applications 2012/006071, “Laser pyrolysis reactor and method related for synthesizing silicon/germanium nanoparticles ink” in which the synthesis method for preparing the silicon/germanium nanoparticles by laser pyrolysis is disclosed, Korea publication of unexamined patent applications 10-1363478, “Preparing method of germanium nanoparticles by using photolysis of gas phase molecules”, in which the tetra-methyl germanium gas is irradiated by the laser pulse and photo-decomposed, producing 70 to 80% yield of the nanoparticles, and Korea publication of unexamined patent applications 10-0840622, “Nanoparticle preparation system and method using the same” in which the laser beam is irradiated to the bulk target comprising at least one of the chalcogenide compounds such as germanium antimony group, germanium bismuth telluride group, germanium antimony selenide group, germanium bismuth selenide group, indium antimony telluride group, indium bismuth telluride group, indium antimony selenide group, indium bismuth selenide group, indium antimony germanide group, gallium antimony telluride group, gallium bismuth telluride group, gallium selenium telluride group, gallium antimony selenide group, gallium bismuth selenide group, stannum antimony telluride group, stannum bismuth telluride, stannum antimony selenide group, and stannum bismuth selenide.

Said nanoparticle preparation methods by laser heating have advantage of producing high purity particles, but have problem of the low production yield which consequently generates the residual products of unreacted toxic source gases that may cause environmental damage if discarded. Also, the reuse of residual products by recovery requires the complicated system and the high cost.

### SUMMARY OF THE INVENTION

Accordingly, the present invention has been made to solve the aforementioned problems occurring in the related art, and it is an object of the present invention to provide a method for preparing nanoparticles by using laser wherein the laser beam is irradiated to the mixture of a source material gas and a hexafluoride (SF₆) catalyst gas, thereby improving the production yield of nanoparticles due to the catalyst gas.

More particularly, the present invention provides the method for preparing the nanoparticles by using the laser wherein the laser beam of wavelength having the excellent energy absorption by the mixture gas of source material gas and catalyst gas is irradiated to the mixture gas so as to increase the reactivity of the source material gas with energy saved, which brings the effects of solving the problems of damaging environment due to the unreacted toxic source material gas incurred by the low production yield of the conventional nanoparticle preparation method and of making system complicated with the high cost when the discarded source gas is recovered and reused.

### Technical Solution

To achieve the above and other objects, in accordance with an embodiment of the present invention, there is provided the method for preparing nanoparticles by using the laser wherein the laser beam is irradiated to the mixture gas of a source material gas and a hexafluoride (SF₆) catalyst gas, which is supplied into the reaction chamber.

Said mixture gas is made up of 100 volume part of the source material gas and 20-40 volume part of the hexafluoride (SF₆) gas, and in order to control the characteristics of nanoparticles generated, said mixture gas is made up of 100 volume part of the source material gas and 100-400 volume part of the hydrogen (H₂) gas.

Said laser beam is generated by CO₂ laser, and irradiates as the continuous laser beam having the wavelength of 10.6 μm. The internal pressure of said reaction chamber is 100-500 torr.

In addition, said source material gas comprises at least one of silicon compound or germanium compound.

### Advantageous Effect

The present invention is disclosed in order to solve the problem of low production yield of the conventional nanoparticle preparation method by using laser and provides a preparation method of irradiating the laser to the mixture gas of a source material gas and a hexafluoride (SF₆) catalyst gas, thereby improving the production yield of nanoparticles due to the catalyst gas. In particular, the present invention provides the method of improving the production yield of nanoparticles with energy saved by irradiating the laser of wavelength having the excellent energy absorption by the mixture gas of source material gas and catalyst gas in the attempts to prevent the waste of high cost source material gas incurred by the low production yield of the conventional nanoparticle preparation method as well as to save the energy consumed as the most of energy is lost in thermal energy to decompose the molecular bonds of the source material gas.

### BRIEF DESCRIPTION OF THE DRAWINGS

FIG. 1 is the schematic view showing the conventional configuration of the nanoparticle synthesis equipment by laser heating.

FIG. 2 is the schematic view illustrating the preparation process of nanoparticles according to the preferred embodiment of the present invention.

FIG. 3 is the schematic view of the laser pyrolysis set-up enlarged for A part in FIG. 2.

FIG. 4 is the graph showing the conversion rate from gas to solid according to the flux condition of the catalyst gas (SF₆) and hydrogen gas (H₂)

FIG. 5 is the photograph image showing the reaction flame by the laser pyrolysis.

FIG. 6 is the graph showing the luminous spectrum of reaction flame and the enlarged spectrum of FIG. 5.

FIG. 7 is the TEM photographs of the silicon nanoparticles produced according to the gas flow condition (sccm) of the catalyst gas (SF₆).

FIG. 8 is the graph showing the qualitative result of the silicon nanoparticles analyzed by Raman spectroscopy.

FIG. 9 is the graph showing the size distribution of the silicon nanoparticles

FIG. 10 is the TEM photograph of the germanium nanoparticles produced according to the gas flow condition (sccm) of the catalyst gas (SF₆).

FIG. 11 is the TEM photograph of the silicon-germanium nanoparticles.

### DETAILED DESCRIPTION OF THE INVENTION

Hereinafter, the method for preparing the nanoparticles by using the laser according to the preferred embodiment of the present invention will be described in detail with reference to the accompanying drawings. The contents that a person in the art can easily understand will be abbreviated or omitted and the contents related to the present invention will be described with the drawings.

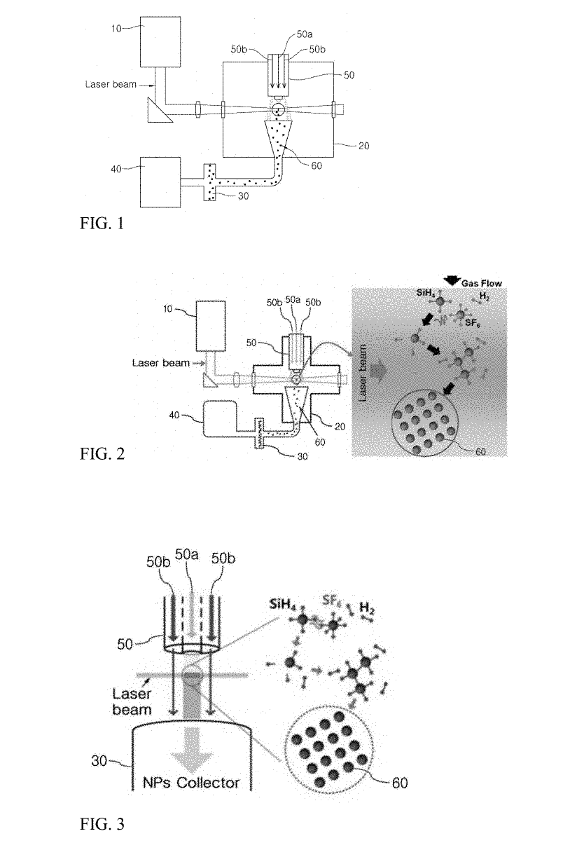

The preparation method of nanoparticles according to the preferred embodiment of the present invention is to produce the nanoparticles (NPs) by the equipment using laser as shown in FIG. 1 wherein the laser is irradiated to the mixture gas of source material gas and hexafluoride (SF₆) catalyst gas which are supplied into the reaction chamber (20).

The fundamental principle of the present invention is based on the fact that the laser of wavelength having the excellent energy absorption by the mixture gas of source material gas and catalyst gas is irradiated so as to prevent the waste of the energy as the most of energy is consumed in thermal energy to decompose the molecular bonds of the source material gas, which improves the production yield of Si-NPs and thus effects the energy saving. The energy required for decomposing the molecular bonds (Si—H) of the source material gas is relatively small and the most of energy is wasted in thermal energy in the conventional method for preparing nanoparticles by using laser. In order to compensate this problem, the present invention selected the catalyst gas and the proper laser wavelength to produce Si-NPs.

In the present invention, said mixture gas is made up of 100 volume part of the source material gas and 20-40 volume part of the hexafluoride (SF₆) gas.

As the mixture gas is supplied with the carrier gas into the reaction chamber, the CO₂ laser wavelengths are matched with the absorption regions of the source material gases such as monosilane (SiH₄), silicon tetrachloride (SiCl₄), germanium (GeH₄), germanium tetrachloride (GeCl₄) or tetra-methyl germanium[Ge(CH₃)] so that the laser energy is readily absorbed exciting the molecules such as monosilane or tetra-methyl germanium, and thereby decomposes Si—H and Ge—CH₃ bonds due to the strong vibration of the molecules of monosilane or tetra-methyl germanium leaving silicon or germanium radicals. The silicon or germanium radicals thus generated develop into the nucleus of the silicon and germanium nanoparticles by the homogenous nucleation and grow by combining the surrounding silicon or germanium radicals. Therefore, the surrounding condition of the silicon or germanium radicals and the duration time for which the nuclei of silicon nanoparticle or the nuclei of germanium nanoparticle stay in the reaction region are the important factors in controlling the size and property of Si-NPs or Ge-NPs. At this time, the catalyst gas SF₆ is mixed in while SiH₄ or Ge(CH₃)₄ are thermally decomposed and transfers the energy by the collision of the molecules, thereby increasing the conversion rate from the source gas to NPs.

If the mixed amount of the catalyst gas is below the certain amount, the rate of decomposition by the reaction with the source gas can be lowered and decrease the production yield, whereas if the mixed amount of the catalyst gas exceeds the certain amount, the explosion occurs during the reaction between SiH₄ and SF₆ and decrease the production yield of Si-NPs with hazard incurred.

In addition, said source material gas could be any substance that can produce nanoparticles as the source gas is decomposed and reacted by the application of the laser energy. Specifically, said source material gas may comprise at least one of silicon compound or germanium compound, and more specifically, comprise at least one of SiCl₄, GeH₄, GeCl₄ and Ge(CH₃)₄.

Moreover, the source material gas according to an embodiment of the present invention is not limited to the compounds listed above but can be any compound that can be decomposed by the laser heating.

In order to control the characteristics of nanoparticles generated, said mixture gas is made up of 100 volume part of the source material gas and 100-400 volume part of the control gas, and supplied into the reaction chamber. If the mixed amount of the control gas is below the certain amount, the explosion phenomenon during the reaction between SiH₄ and SF₆ could not be controlled, whereas if the mixed amount of the control gas exceeds the certain amount, the crystallization rate of nanoparticles may get smaller and the production yield may decrease. The control gas that can suppress the explosion reaction may comprise at least one of hydrogen, nitrogen, argon, and helium.

Said laser beam is generated by CO₂ laser, and is irradiated as the continuous laser beam having the wavelength of 10.6 μm. The CO₂ laser used in the present invention preferably has the maximum power of 50-60 W, but the power can be adjusted depending on the equipment scale or the volume to be produced, e.g. as high as 6,000 W.

Also, the internal pressure of said reaction chamber is preferably 100-500 torr. If the internal pressure is below the certain range, the decomposition of the source gas does not occur and the yield is decreased, whereas if the internal pressure is exceeds the certain range, the quality can be degraded as the nanoparticles are agglomerated.

FIG. 2 and FIG. 3 illustrate the process in which SiH4 gas is decomposed by the laser and grows to the nanoparticle (60). SF₆ has great absorption at the wavelength of 10.6 μm and the absorbed energy is transferred to SiH₄ more efficiently, which can decompose more Si—H bonds and generate more Si-NPs. When the SiH₄ gases are not reacted and discarded, it makes serious problems. Firstly, the hazard gas harms the environment. Secondly, in terms of cost, when the unreacted gas is recovered and reused, the system required gets complicated and costs high. But, according to the present invention, the source gas, SiH₄ for producing Si-NPs is reacted with SF₆ which is the reaction gas capable of causing explosive reaction under the excited state by the external energy. The reaction equation 1 is as follows.

3SiH₄+2SF₆−>2S+3SiF₄+2HF+5H₂

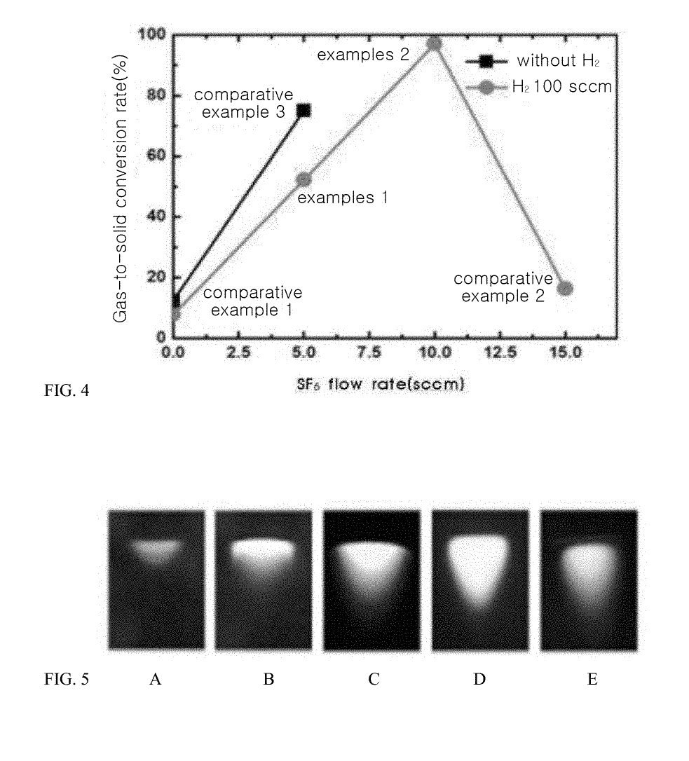

In the reaction equation 1, it is found that the silicon nanoparticles (Si-NPs) are not produced. The reaction starts with the decomposition of SF₆ when the very high energy is applied, and then proceeds with the explosive reaction due to the decomposed reactive molecules causing explosion to occur by the chain reaction. Accordingly, it is important to control the energy so that SF₆ is not put under the very high energy, which can be done by reducing the laser power or the energy of reaction gases. Since the production amount of Si-NPs can be reduced at the reduced laser power, it is preferable to dilute the reaction gases by the different gases or to reduce the gas pressure. That is, FIG. 4 shows the production yield (Gas-to-solid conversion rate) of the silicon nanoparticles when the reaction gases mixed with source material gas and catalyst gas are diluted by the hydrogen gas. The solid black line in FIG. 4 represents the yield when SiH₄ gas is infused with SF₆ gas without H₂ gas. The infusion of SF₆ gas causes the production yield to increase rapidly, but if SF₆ gas is supplied to above the certain amount, the yield decreases as the reaction changes so easily to the explosion reaction and even the process becomes dangerous. Such explosion reaction can be restrained significantly if H₂ gas is supplied with the reaction gases of SiH₄ gas and SF₆ gas as shown in the orange color solid line in the figure. As the gases that can restrain the explosion reaction, hydrogen, nitrogen, argon and helium gases, etc. can be used.

Hereinafter the method for preparing nanoparticles by using laser is described with the embodiments according to the present invention, but the present invention is not limited to the embodiments described below.

1. Equipment for Preparing Nanoparticles

The equipment used in the embodiment as shown in FIG. 1 is the conventional equipment for preparing nanoparticles, comprising laser emitter (10) that emits the laser generated by CO₂ laser with the maximum power of 60 W, reaction chamber (20), collector (30), vacuum pump (40), source material supply nozzle (50a) for supplying the source material into said reaction chamber (20) and infusion section (50) having carrier gas supply nozzle (50b) for supplying carrier gas.

2. Preparation of Nanoparticles

Hereinafter, the unit sccm(standard cubic centimeters per minute) used in the example represents the unit of flux.

### Example 1

The mixture gas consisting of 25 sccm(100 volume part) of the source material gas (SiH₄), 100 sccm(400 volume part) of the control gas (H₂), and 5 sccm(20 volume part) of the catalyst gas (SF₆), was supplied through the supply nozzle (50a) into the reaction chamber (20) having the internal pressure of 100 torr. Into the mixture gas was irradiated for 1 hour the continuous laser beam having wavelength of 10.6 μm through the laser emitter (10). As shown in FIGS. 2 and 3, the silicon nanoparticles (60) were produced and collected by the collector (30) by using the vacuum pump (40). In this example, the yield of Si-NPs having the particle size of 10-30 nm was 52.4%.

### Example 2

The mixture gas consisting of 25 sccm(100 volume part) of the source material gas (SiH₄), 100 sccm(400 volume part) of the control gas (H₂), and 10 sccm(40 volume part) of the catalyst gas (SF₆), was supplied through the supply nozzle (50a) into the reaction chamber (20) having the internal pressure of 500 torr. Into the mixture gas was irradiated for 3 hour the continuous laser beam having wavelength of 10.6 μm through the laser emitter (10). As shown in FIGS. 2 and 3, the silicon nanoparticles (60) were produced and collected by the collector (30) by using the vacuum pump (40). In the example 2, the yield of Si-NPs having the particle size of 10-30 nm was 97.1%.

### Example 3

The mixture gas consisting of 25 sccm(100 volume part) of the source material gas (GeH₄), 100 sccm(400 volume part) of the control gas (H₂), and 5 sccm(20 volume part) of the catalyst gas (SF₆) was used, and Ge-NPs were prepared by the method same as the example 1. The particle size of Ge-NPs was 20-100 nm and the yield was 53.7%.

### Example 4

The mixture gas consisting of 25 sccm(100 volume part) of the source material gas (GeH₄), 100 sccm(400 volume part) of the control gas (H₂), and 10 sccm(40 volume part) of the catalyst gas (SF₆) was used, and Ge-NPs were prepared by the method same as the example 2. The particle size of Ge-NPs was 20-100 nm and the yield was 90.3%.

### Example 5

The mixture gas consisting of 25 sccm(100 volume part) of the source material gas (GeH₄), 25 sccm(100 volume part) of the source material gas (SiH₄), 100 sccm(400 volume part) of the control gas (H₂), and 10 sccm(40 volume part) of the catalyst gas (SF₆) was used, and SiGe-NPs were prepared by the method same as the example 2. The particle size of SiGe-NPs was 20-100 nm and the yield was 79.5%.

### Comparative Example 1

The mixture gas consisting of 25 sccm(100 volume part) of the source material gas (SiH4), and 100 sccm(400 volume part) of the control gas (H₂) was used without the catalyst gas (SF6), and Si-NPs were prepared by the method same as the example 1. In this comparative example 1, the yield of Si-NPs having the particle size of 10-30 nm was 9.4%.

### Comparative Example 2

The mixture gas consisting of 25 sccm(100 volume part) of the source material gas (SiH₄), 100 sccm(400 volume part) of the control gas (H₂), and 15 sccm(60 volume part) of the catalyst gas (SF₆) was used, and Si-NPs were prepared by the method same as the example 2. In this comparative example 2, the yield of Si-NPs having the particle size of 10-30 nm was 16.3%.

### Comparative Example 3

The mixture gas consisting of 25 sccm(100 volume part) of the source material gas (SiH₄), and 5 sccm(20 volume part) of the catalyst gas (SF₆) was used without H₂ gas and Si-NPs were prepared by the method same as the example 1. In the example 2, the yield of Si-NPs having the particle size of 10-30 nm was 75.0%.

### Comparative Example 4

The mixture gas consisting of 25 sccm(100 volume part) of the source material gas (GeH₄) and 100 sccm(400 volume part) of the control gas (H₂) was used without the catalyst gas (SF₆), and Ge-NPs were prepared by the method same as the example 3. The particle size of Ge-NPs was 50-80 nm and the yield was 1.7%.

### Comparative Example 5

The mixture gas consisting of 25 sccm(100 volume part) of the source material gas (GeH₄), and 5 sccm(20 volume part) of the catalyst gas (SF₆) was used without H₂ gas and Ge-NPs were prepared by the method same as the example 3. The particle size of Ge-NPs was 20-100 nm and the yield was 62.6%.

3. Evaluation of the Method for Preparing Nanoparticles

Evaluation of said method 2 as shown in the graph of FIG. 4 confirmed that the production yields of Si-NPs or Ge-NPs are far better in the examples 1 or 5 than in the comparative examples 1 or 5.

All the examples 1, 2 and the comparative example 2 used SiH₄ gas mixed with the control gas H₂ and the catalyst gas SF₆, but the production yield of Si-NPs was higher in the example 1 and 2 than in the comparative example 2. Also, it was found that the yield in the comparative example 1 was lowest as the catalyst gas (SF₆) was not used. Although it was found as shown in FIG. 4 that the yield was far better in the comparative example 3 than in the example 1 as the comparative example 3 used the mixture of SiH₄ gas and SF₆ gas only, thereby increasing the yield rapidly by not using H₂ gas, the explosion in the reaction process of SiH₄ and SF₆ may decrease the yield significantly and incur the dangerous problem during the preparation process of nanoparticles. The examples 3 and 4 using GeH₄ as the source material gas showed the increased yield compared with the comparative examples 4 and 5 which used neither of SF6 nor H2 gas.

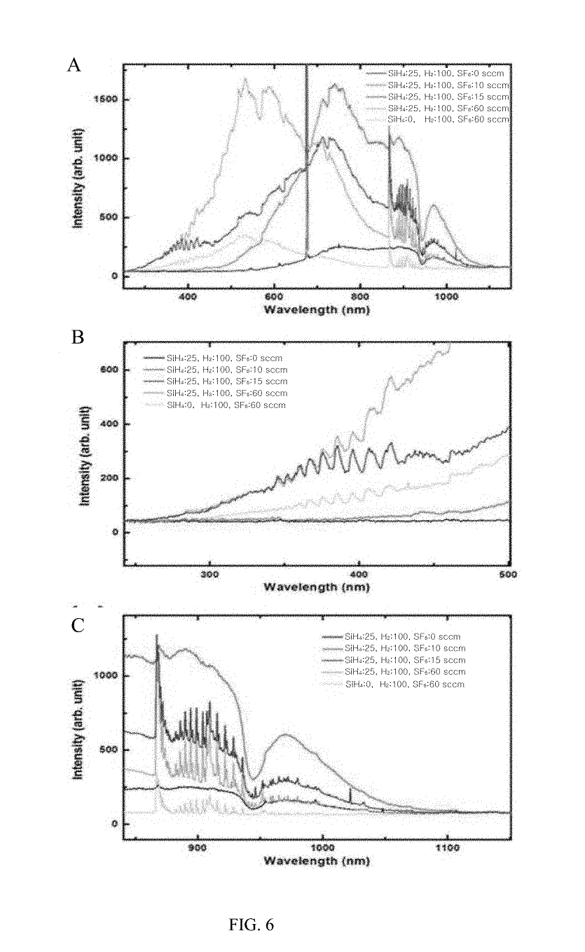

FIG. 4 is the graph showing the conversion rate from gas to solid according to the flux condition of the catalyst gas (SF₆) and hydrogen gas (H₂). FIG. 5 is the photograph image showing the reaction flame by the laser pyrolysis. FIG. 6 is the graph showing the luminous spectrum of reaction flame and the enlarged spectrum of FIG. 5. FIGS. 5A and 5B are the digital images showing the reaction flames generated by the thermal decomposition during the process of preparing Si-NPs where the flame images are taken as the flux conditions of SiH₄:H₂:SF₆ at sccm unit change to (A) 25:100:0, (B) 25:100:10, (C)25:100:15, (D)25:100:60 and (E) 0:100:60, respectively. The remarkable change in reaction flame in FIG. 5 shows that as the catalyst gas SF₆ is increased, the flame color is changed to the white color and the flame size grows, which confirms the basis of the explosion reaction. Also, as shown in FIG. 6, the spectrum of the reaction flame in FIG. 5 can be analyzed. The explosion reaction between the catalyst gas and the silane gas can be characterized by the periodic peaks in the spectrum. These periodic peaks are due to the HF molecules generated by the explosion reaction and differentiated from the spectrum of the suppressed explosion reaction. The spectrum of the high yield process due to the suppressed explosion reaction shows that only the flame intensity increases without the periodic peaks, which matches well the result shown in FIG. 5.

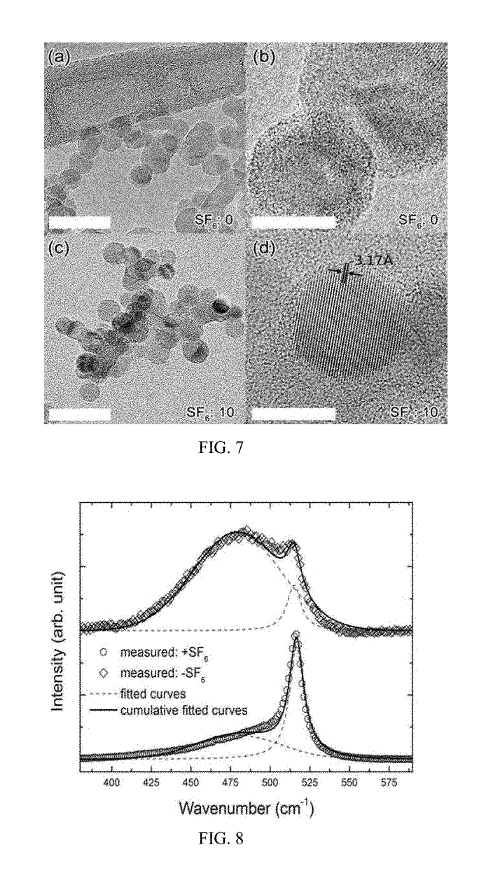

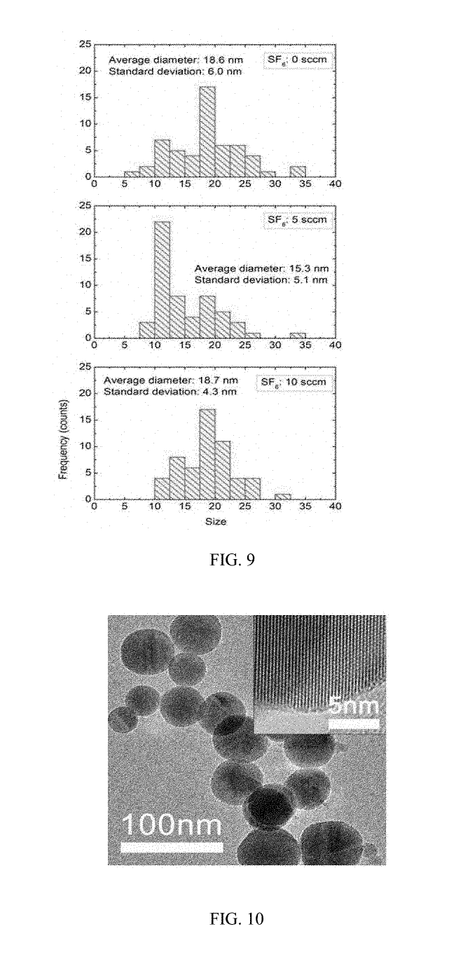

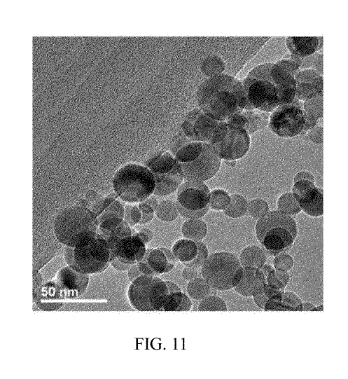

FIG. 7 is the TEM photographs of the silicon nanoparticles produced according to the gas flux condition (sccm) of the catalyst gas (SF₆). TEM photograph (a) of the comparative example 1 is the case of mono-silane 25 sccm, hydrogen 100 sccm and no catalyst gas. TEM (b) is the enlarged photograph of (a) and show the typical silicon nanoparticles in which most of overall areas show the pattern with silicon atoms arranged within the particle of 10-30 nm size and also substantial areas show the polycrystalline and amorphous patterns. TEM (c) of the example 1 is the photograph of nanoparticles of the sample produced at the yield of 97.2% from mono-silane 25 sccm, hydrogen 100 sccm and catalyst gas 10 sccm. TEM (d) is the enlarged one of (c) and shows the crystallinity is well developed with most of them single crystalline. Accordingly, it can be found that as shown in FIG. 7, the silicon nanoparticles prepared by using the catalyst has the outstanding crystallinity with most of them single crystalline. Such crystallinity can be analyzed qualitatively by Raman spectroscopy as shown in FIG. 8. Typically, in the Raman measurement, the crystalline silicon exhibits very sharp signal at the wavenumber 520 and the amorphous silicon broad signal at around the wavenumber 480. As shown in FIG. 7, the silicon nanoparticles produced without using the catalyst gas show not only the sharp signal at the wavenumber 520, but more apparently broad signal at around 480, whereas the particles produced with the catalyst exhibit the relatively more apparent signal at the wavenumber 520, which indicates that the nanoparticles prepared by using catalyst gas have better crystallinity. Furthermore, as shown in FIG. 9, the particle size distribution of silicon particles is more uniform in the particles prepared by the catalyst gas. Also, as shown in FIG. 10, the germanium particles have the size of 20-100 nm and are the individual crystalline particles with the distinguished crystalline pattern. FIG. 11 is the TEM photograph of the silicon-germanium nanoparticles.

Although the present invention has been described with reference to the preferred embodiment in the attached figures, it is to be understood that various equivalent modifications and variations of the embodiments can be made by a person having an ordinary skill in the art without departing from the spirit and scope of the present invention as recited in the claims.

### INDUSTRIAL APPLICABILITY

The present invention is disclosed in order to solve the problem of low production yield of the conventional nanoparticle preparation method by using laser and provides a preparation method of irradiating the laser to the mixture gas of a source material gas and a hexafluoride (SF₆) catalyst gas, thereby improving the production yield of nanoparticles due to the catalyst gas. In particular, the present invention provides the method of improving the production yield of nanoparticles with energy saved by irradiating the laser of wavelength having the excellent energy absorption by the mixture gas of source material gas and catalyst gas in the attempts to prevent the waste of high cost source material gas incurred by the low production yield of the conventional nanoparticle preparation method as well as to save the energy consumed as the most of energy is lost in thermal energy to decompose the molecular bonds of the source material gas.

1. A method for preparing nanoparticles by using a laser wherein the laser is irradiated to the mixture gas of a source material gas and a hexafluoride (SF₆) catalyst gas supplied into a reaction chamber.

2. The method for preparing nanoparticles by using the laser of claim 1, wherein said mixture gas is made up of 100 volume part of the source material gas and 20-40 volume part of the hexafluoride (SF₆) gas.

3. The method for preparing nanoparticles by using the laser of claim 2, wherein, in order to control the characteristics of the nanoparticles generated, said mixture gas is made up of 100 volume part of the source material gas and 100-400 volume part of the hydrogen (H₂) gas.

4. The method for preparing nanoparticles by using the laser of claim 1, wherein said laser beam is generated by CO₂ laser, and is irradiated as the continuous laser beam having the wavelength of 10.6 μm.

5. The method for preparing nanoparticles by using the laser of claim 1, wherein the internal pressure of said reaction chamber is 100-500 torr.

6. The method for preparing nanoparticles by using the laser of claim 2, wherein said source material gas comprises at least one of silicon compound or germanium compound.

7. The method for preparing nanoparticles by using the laser of claim 3, wherein said source material gas comprises at least one of silicon compound or germanium compound.

8. The method for preparing nanoparticles by using the laser of claim 3, wherein said source material gas comprises at least one silicon compound.

9. The method for preparing nanoparticles by using the laser of claim 3, wherein said source material gas comprises at least one germanium compound.

10. A nanoparticle prepared by the method of claim 1.
